(19) United States
(12) Patent Application Publication
(10) Pub. No.: US 2008/0086301 A1
(43) Pub. Date: Apr. 10, 2008

(54) Audio communication apparatus, audio communication system, audio communication control method, and audio communication control program

(75) Inventor: Makoto Tachibana, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Ericsson Mobile Communications Japan, Inc., Tokyo (JP)

(21) Appl. No.: 11/902,720

(22) Filed: Sep. 25, 2007

(30) Foreign Application Priority Data
Oct. 10, 2006 (JP) 2006-276584

(51) Int. Cl. G10L 19/00

(52) U.S. Cl. 704/201

(57) ABSTRACT

An audio communication apparatus performs communication for at least voice communication. The apparatus includes a voice input portion for inputting voice; a voice correction processor portion for performing, by necessity, a voice correction process of the voice input from the voice input portion; a communication portion for performing communication with a far-end communication apparatus; and a controller portion for executing control during voice communication being performed with the far-end communication apparatus through the communication portion. Thereby, data regarding a voice correction function of the voice correction processor portion are transmitted, by necessity, from the communication portion to the far-end communication apparatus. Further, when a modification request for the voice correction function of the voice correction processor portion of the audio communication apparatus is received from the far-end communication apparatus through the communication portion, the voice correction process of the voice correction processor portion is controlled in accordance with the modification request.

### CROSS REFERENCES TO RELATED APPLICATIONS

The present invention contains subject matter related to Japanese Patent Application JP 2006-276584 filed in the Japanese Patent Office on Oct. 10, 2006, the entire contents of which being incorporated herein by reference.

### BACKGROUND OF THE INVENTION

1. Field of the Invention

The present invention relates to an audio communication apparatus and system for performing, for example, voice communication. The invention further relates to an audio communication control method and program for use in such voice communication. (Note: Throughout the present document, unless otherwise specifically mentioned, “audio” refers to any audible sounds).

2. Description of the Related Art

In recent years, there have been developed systems of the type in which an audio correction process, such as noise cancellation, is performed in a transmitting-side communication apparatus in voice communication between communication apparatuses, such as mobile phone terminals, capable of performing voice communication.

For example, Japanese Unexamined Patent Application Publication No. 09-326844 (Patent Publication 1) discloses a low-noise voice communication apparatus and method. According to the publication, a specific component of voice is removed, and a voice signal after removal of the specific component is amplified to acquire an output of a fixed level, and then is transmitted. Thereby, a transmission-side apparatus is enabled to reduce ambient environmental noise excepting communication voice, and to transmit a transmission voice signal with less level fluctuation and high transmission sound quality to a receiving-side apparatus.

### SUMMARY OF THE INVENTION

However, in a case such as described above, in which a transmission-side communication apparatus includes a voice correction function, even data including inherently necessary data is lost by an voice correction process depending on the situation of communication. More specifically, for example, a case is assumed in which communication is carried out in a situation where ambient, environmental noise is significantly large, or the component of environmental noise is very similar to the component of the communication voice during the communication. In such a case, even inherently necessary voice component and voice level, for example, are likely to be corrected (or removed from the transmission voice) by the voice correction process executed in the transmission-side communication apparatus. Particularly, in the case where a voice correction function of the transmitting side communication apparatus would be enhanced in the future, probability of problems such as described above would increase.

For example, suppose that inherently necessary data is lost from transmission voice by the voice correction function of the transmission-side communication apparatus. In this case, only receiving voice remaining after lost of the inherently necessary data can be received, so that significantly less audible can be received in the receive-side communication apparatus.

In addition, in a case where, for example, a voice correction process for removing ambient environmental sounds is under way in the transmission-side communication apparatus, a user of the receive-side communication apparatus can hear only transmission voice transmitted from a user of the transmission-side communication apparatus. However, what the user of the receive-side communication apparatus desires to hear is not limited to only the voice of the talker, but a case can take place in which the user desires to hear also ambient environmental sounds around the talker.

Under these circumstances, it would be desirable to provide an audio communication apparatus, an audio communication system, an audio communication control method, and an audio communication control program that are capable of preventing occurrence of a state where inherently necessary data is lost by a voice correction function of a transmission-side audio communication apparatus from transmission voice to thereby be able to obtain easy-to-hear receiving voice through a receive-side communication apparatus, and that are capable of being effectively used even in a case where a user of the receive-side communication apparatus desires to hear transmission voice together with ambient environmental sounds, thereby making it possible to effectively use, by necessity, the voice correction function of the transmission-side audio communication apparatus.

According to one embodiment of the present invention, an audio communication apparatus for performing communication for at least voice communication is provided. The apparatus includes a voice input portion for inputting voice; a voice correction processor portion for performing, by necessity, a voice correction process of the voice input from the voice input portion; a communication portion for performing communication with a far-end communication apparatus; and a controller portion for executing control during voice communication being performed with the far-end communication apparatus through the communication portion so that data regarding a voice correction function of the voice correction processor portion are transmitted, by necessity, from the communication portion to the far-end communication apparatus, and when a modification request for the voice correction function of the voice correction processor portion of the audio communication apparatus is received from the far-end communication apparatus through the communication portion, the voice correction process of the voice correction processor portion is controlled in accordance with the modification request.

According to another embodiment of the present invention, an audio communication apparatus for performing at least voice communication is provided that includes a communication portion for performing communication with a far-end communication apparatus; a presentation portion for performing information presentation to a user; an operation input portion for inputting contents of an input operation of the user; and a controller portion for executing control during voice communication being performed with the far-end communication apparatus through the communication portion so that when data regarding a voice correction function of the far-end communication apparatus is received through the communication portion, information in accordance with the data regarding a voice correction function is presented to the user through the communication portion, and when contents of a predetermined operation regarding modification of the voice correction function of the far-end communication apparatus has been input from the user through the operation input portion, data of a modification request regarding the voice correction function corresponding to the predetermined operation are generated and transmitted from the communication portion to the far-end communication apparatus.

According to another embodiment of the present invention, an audio communications system including audio communication apparatuses for performing communication for at least voice communication is provided. In the system, a transmission-side audio communication apparatus includes at least a voice input portion for inputting voice; a voice correction processor portion for performing, by necessity, a voice correction process of voice input from the voice input portion; a communication portion for performing communication with a far-end communication apparatus; and a controller portion for executing control during voice communication being performed with the far-end communication apparatus through the communication portion so that data regarding a voice correction function of the voice correction processor portion are transmitted, by necessity, from the communication portion to the far-end communication apparatus, and when a modification request for the voice correction function of the voice correction processor portion of the audio communication apparatus is received from the far-end communication apparatus through the communication portion, the voice correction process of the voice correction processor portion is controlled in accordance with the modification request. A receive-side audio communication apparatus including at least a communication portion for performing communication with a far-end communication apparatus; a presentation portion for performing information presentation to a user; an operation input portion for inputting contents of an input operation of the user; and a controller portion for executing control during voice communication being performed with the far-end communication apparatus through the communication portion so that when data regarding a voice correction function of the far-end communication apparatus is received through the communication portion, information in accordance with the data regarding a voice correction function is presented to the user through the communication portion, and when contents of a predetermined operation regarding modification of the voice correction function of the far-end communication apparatus has been input from the user through the operation input portion, data of a modification request regarding the voice correction function corresponding to the predetermined operation are generated and transmitted from the communication portion to the far-end communication apparatus.

According to another embodiment, an audio communication control method for performing communication for at least voice communication is provided. The method includes the steps of inputting voice through an voice input portion; performing, by necessity, a voice correction process of the voice input from the voice input portion, the voice correction process being performed by a voice correction processor portion; during voice communication being performed with a far-end communication apparatus through a communication portion, transmitting data regarding a voice correction function of the voice correction processor portion, by necessity, from the communication portion to the far-end communication apparatus under control of a controller portion; and during voice communication being performed with the far-end communication apparatus through the communication portion, when a modification request for the voice correction function of the voice correction processor portion of the audio communication apparatus is received from the far-end communication apparatus through the communication portion, executing control of the voice correction process of the voice correction processor portion in accordance with the modification request, the control being executed by the controller portion.

According to another embodiment of the present invention, an audio communication method for performing at least voice communication is provided. The method includes the steps of during voice communication being performed with a far-end communication apparatus, when data regarding a voice correction function of the far-end communication apparatus is received through the communication portion, performing presentation of information in accordance with the data regarding a voice correction function to a user through the communication portion, the presentation being performed under control of a controller portion; and during voice communication being performed with the far-end communication apparatus, when contents of a predetermined operation regarding modification of the voice correction function of the far-end communication apparatus has been input from the user through an operation input portion, performing generation and transmission of data of a modification request regarding the voice correction function corresponding to the predetermined operation are generated and transmitted from the communication portion to the far-end communication apparatus, the generation being performed by the controller portion, and the transmission being performed under control of the controller portion.

According to another embodiment of the present invention, there is provided an audio communication control program for an audio communication apparatus that performs communication for at least voice communication, the apparatus including a voice input portion for inputting voice and a communication portion for performing communication with a far-end communication apparatus. The program includes causing a computer to function as a voice correction processor portion that performs, by necessity, a voice correction process of the voice input from the voice input portion; and causing the computer to function as a controller portion that executes control during voice communication being performed with the far-end communication apparatus through the communication portion so that data regarding a voice correction function of the voice correction processor portion are transmitted, by necessity, from the communication portion to the far-end communication apparatus, and when a modification request for the voice correction function of the voice correction processor portion of the audio communication apparatus is received from the far-end communication apparatus through the communication portion, the voice correction process of the voice correction processor portion is controlled in accordance with the modification request.

According to another embodiment of the present invention, there is provided an audio communication control program for an audio communication apparatus that performs communication for at least voice communication, the apparatus including a communication portion for performing communication with a far-end communication apparatus, a presentation portion for performing information presentation to a user of the audio communication apparatus, and an operation input portion for inputting contents of an input operation of the user. The program includes causing a computer to function as a controller portion for executing control during voice communication being performed with the far-end communication apparatus through the communication portion so that when data regarding a voice correction function of the far-end communication apparatus is received through the communication portion, information in accordance with the data regarding a voice correction function is presented to the user through the communication portion, and when contents of a predetermined operation regarding modification of the voice correction function of the far-end communication apparatus has been input from the user through the operation input portion, data of a modification request regarding the voice correction function corresponding to the predetermined operation are generated and transmitted from the communication portion to the far-end communication apparatus.

According to the above-described embodiments, the transmission-side audio communication apparatus transmits the data regarding the voice correction function of its own. Thereby, the receive-side audio communication apparatus is able to learn the type of a voice correction process currently being under way in the transmission-side audio communication apparatus from the data regarding the voice correction function transmitted from the transmission-side audio communication apparatus. Then, when necessary, the receive-side audio communication apparatus transmits to the transmission-side audio communication apparatus a modification request regarding the voice correction function of the transmission-side audio communication apparatus. In response, the transmission-side audio communication apparatus executes modification control of the voice correction function in accordance with the modification request.

Thus, according to the embodiments of the present invention, in voice communication being under way between two communication apparatuses (transmission-side and receive-side apparatuses), when the transmission-side apparatus has a voice correction function, the state of the voice correction function of the transmission-side apparatus can be known and can be operated by making a modification request in the receive-side apparatus. The configuration thus arranged makes it possible to prevent occurrence of a state where inherently necessary data is lost by the voice correction function of the transmission-side apparatus. Further, the configuration makes it possible to obtain easy-to-hear receiving voice through the receive-side apparatus. Further, the configuration makes it possible to address even a case where the user of the receive-side apparatus desires to hear transmission voice together with ambient environmental sounds, thereby to effectively use, by necessity, the voice correction function of the transmission-side apparatus.

### BRIEF DESCRIPTION OF THE DRAWINGS

FIG. 1 is a schematic view of the configuration of a mobile phones system of an embodiment of the present invention, and more specifically, a state of communication of communication voice data, a type of a voice correction function, and an adjustment parameter of a voice correction process of the function;

FIG. 2 is a view showing a display example displayed on a display screen of the receive-side communication apparatus in the event that data regarding the type of the voice correction function and the adjustment parameter of the voice correction process, which data has been sent from the transmission-side audio communication apparatus;

FIG. 3 is a schematic view of the configuration of the mobile phones system of an embodiment of the present invention, and more specifically, a state of communication of a “modification request,” a type of a voice correction function, which type is modified in response to the request, and an adjustment parameter of a voice correction process of the function;

FIG. 4 is a block circuit diagram showing a general interior configuration of a mobile phone terminal according to the present embodiment of the present invention;

FIG. 5 is a flow diagram representing the flow of processing regarding a voice correction function of a transmission-side mobile phone terminal; and

FIG. 6 is a flow diagram representing the flow of processing regarding a voice correction function of a receive-side mobile phone terminal.

### DETAILED DESCRIPTION OF THE PREFERRED EMBODIMENT

With reference to the accompanying drawings, an embodiment of the present invention will be described herebelow.

While the present embodiment will be discussed with reference to examples of a mobile phone terminal and a mobile phones system, the contents to be described herebelow is in any way examples and the present invention is not limited to the examples. The invention can, of course, be adapted to various other mobile phone terminals, such as PDAs (“PDA”: personal digital assistant).

### (General System Configuration)

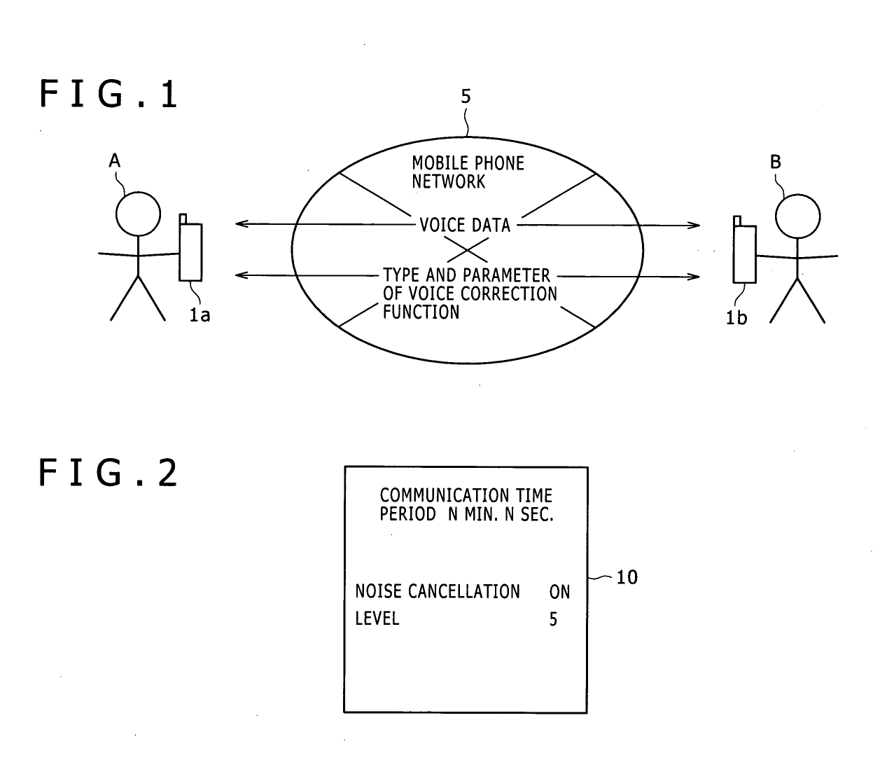

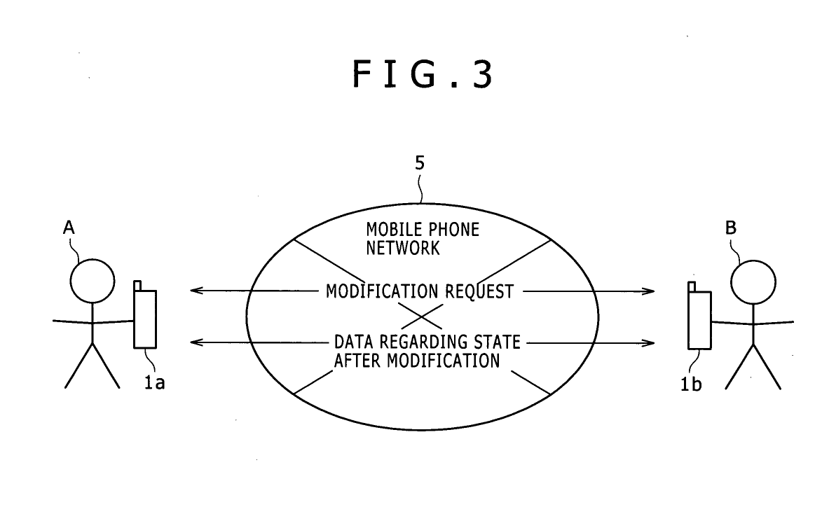

FIGS. 1 and 3 show a general configuration of the mobile phones system according to the embodiment of the present invention. As examples shown in the respective drawings, states are shown in each of which users A and B, respectively, use mobile phone terminals 1a and 1b that are communicable (communicable by way of voice calls) with one another across a mobile phone network 5.

### (Functions of Transmission-Side Mobile Phone Terminal)

With reference to FIG. 1, at least one of the mobile phone terminals 1a and 1b (the terminal 1a of the user A in the present embodiment) includes the following functions. One is a function for executing a predetermined voice correction process of transmission voice of the user A (voice correction function). Another is a function for transmitting transmission voice data and data (*1) regarding at least a voice correction function of the own terminal (1a) ((*1)=data regarding the type of the voice correction function and an adjustment parameter of a voice correction process of the function), for example, in the case of the present embodiment) to a far-end mobile phone terminal (=the mobile phone terminal 1b of the user B).

More specifically, the mobile phone terminal 1a of the user A includes a noise cancellation function as one example of the predetermined voice correction function. The noise cancellation function removes, for example, ambient environmental noise components from a transmission voice signal, and is settable to an “ON/OFF” mode. Further, the mobile phone terminal 1a is adjustable in a voice correction amount (level of a noise cancellation process (or “noise cancellation level,” hereinbelow) in the present example) to, for example, a plurality of levels. In the event of transmission of the transmission voice data to the mobile phone terminal 1b of the user B, the mobile phone terminal 1a transmits thereto data regarding a type of the own voice correction function (i.e., the noise cancellation function in the present example). The data are data indicative of the type of the voice correction function, and data indicative of whether the voice correction function is under execution or inactivation (i.e., whether the noise cancellation function is ON or OFF). Concurrently, the mobile phone terminal 1a transmits data regarding an adjustment parameter of the voice correction process, namely data indicative of the voice correction amount (noise cancellation level).

These items, such as the noise cancellation function serving as the voice correction function, the ON/OFF setting of the function, and the noise cancellation level serving as the adjustment parameter, are in any way examples. However, a plurality of types of voice correction functions may be provided, and the voice correction function may be other than the noise cancellation function. Alternative functions of the noise cancellation function include, for example, a function that adjusts or shifts directivity of a microphone that inputs transmission voice, thereby to prevent entrainment of ambient environmental noise.

In the event of transmission of the data regarding the adjustment parameter of the voice correction process, it is preferable that the mobile phone terminal 1a concurrently transmits data indicative of, for example, a level of a voice correction range settable in the mobile phone terminal 1a and a level of the voice correction range to which a current correction amount corresponds. When the data indicative of the voice correction range and the current correction amount is transmitted from the mobile phone terminal 1a, the current level of the voice correction process in the mobile phone terminal 1a can be known on the side of the mobile phone terminal 1b having received the data.

The data regarding the type of voice correction function and the adjustment parameter of the voice correction process can be transmitted using any way inasmuch as the data can be transmitted or received during voice communication. As one example, the transmission is carried out using, for example, a currently unused channel or an administration channel. In this case, the currently unused channel refers to a channel other than communication channels being used for voice communication of those usable in e-mail and packet communication or data communication using a call control server and mobile phone network.

### (Display Example on Display Screen in Receive-Side Mobile Phone Terminal)

FIG. 2 is a view showing an example of information displayed on a display screen of the mobile phone terminal 1b. The example is in the event that the transmission voice data and the data regarding the type of the voice compensation function and the adjustment parameter of the voice compensation process are transmitted from the mobile phone terminal 1a, and the data are received in the mobile phone terminal 1b.

Thus, as shown in FIG. 2, the mobile phone terminal 1b receives the data regarding the type of voice correction function and the adjustment parameter of the voice correction process from the far-end of the voice communication, namely, the mobile phone terminal 1a. In this case, the mobile phone terminal 1b displays the data, i.e., the type of voice correction function and the adjustment parameter, on the own display screen, thereby to present the state of the voice correction function of the mobile phone terminal 1a to the user B. More specifically, shown in FIG. 2 is a display example displayed on the display screen of the mobile phone terminal 1b in the event that, in the mobile phone terminal 1a, the noise cancellation function is set to the ON mode, and the correction amount of the noise cancellation (process) is adjusted to level “5.“

For presentation to the user B, the mobile phone terminal 1b may output information regarding the type of voice correction function and the adjustment parameter of the voice correction process by voice instead of or together with display on the display screen.

When received the data regarding the type of voice correction function and the adjustment parameter of the voice correction process and, in addition, the data indicative of the voice correction range settable in the mobile phone terminal 1a and the current correction amount, the mobile phone terminal 1b may display the correction amount of the noise cancellation in the form of, for example, a level meter. Thereby, the mobile phone terminal 1b may present to the user B the settable level of the voice correction process and the current level of the voice correction process in the mobile phone terminal 1a.

### (Voice Correction Function Modification Request by Receive Side, and Adjustment Operation for Voice Correction Process)

With reference to FIG. 3, in the present embodiment, at least the other one of the mobile phone terminals 1a and 1b (i.e., the terminal 1b of the user B in the present embodiment) includes a function of transmitting a “modification request” to the transmitting-side mobile phone terminal 1a (i.e., far-end terminal). The request is made for, for example, the ON/OFF operation of the voice correction process or adjustment of the voice correction process in the mobile phone terminal 1a. Transmission of the modification request is executed in response to a predetermined key operation performed by the user B on the mobile phone terminal 1b.

The mobile phone terminal 1a further includes functions for operations, such as ON/OFF setting and adjustment of the voice correction process (of its own) in response to the “modification request” incoming from the mobile phone terminal 1b. Upon receipt of the “modification request” from the mobile phone terminal 1b, the mobile phone terminal 1a executes the operations, such as ON/OFF setting and adjustment of the voice correction process, in response to the “modification request.” Then, mobile phone terminal 1a transmits data indicative of the state after execution of the operations, such as ON/OFF setting and adjustment of the voice correction process (i.e., post-modification data regarding the type of voice correction function and the adjustment parameter of the voice correction process) to the mobile phone terminal 1b that transmitted the “modification request.”

More specifically, the present embodiment of the present invention operates as described hereinbelow. During voice communication between the users A and B through their respective mobile phone terminals 1a and 1b, there can take place the following case. While the voice correction process is in the ON mode in the mobile phone terminal 1a, the voice of the user A is not easy to hear on the side of the mobile phone terminal 1b because the correction amount therefor is excessively large (that is, the intensity level of the voice correction process is excessively high). In this case, the mobile phone terminal 1b is able to transmit a request (“modification request”) to the mobile phone terminal 1a for executing the operations, such as OFF setting of the voice correction process and reduction of the correction amount of the voice correction process. In response to the “modification request,” the mobile phone terminal 1a is able to execute the operations, such as OFF setting of the voice correction process and reduction of the correction amount of the voice correction process. The mobile phone terminal 1a is further able to transmit data indicative of the state after execution of the operations, such as OFF setting and adjustment of the voice correction process, to the mobile phone terminal 1b in response to the “modification request.”

In addition, a case can take place where the voice of the user A is not easily audible because of ambient environmental noise since, for example, the voice correction process is set to the OFF mode and the voice correction amount is excessively small in the mobile phone terminal 1a. Even in this case, the following operations can of course be implemented. In this case, the mobile phone terminal 1b is able to transmit a “modification request” to the mobile phone terminal 1a for carrying out, for example, ON setting of the voice correction process and increase of the correction amount of the voice correction process. In response to the “modification request,” the mobile phone terminal 1a is able to execute operations, such as ON setting of the voice correction process and adjustment for increasing the correction amount of the voice correction process. The mobile phone terminal 1a is further able to transmit data indicative of the state after the execution of the operations, such as ON setting and adjustment of the voice correction process, to the mobile phone terminal 1b as a response to the “modification request.”

Upon receipt of the data indicative of the state after the execution of the operations, such as ON/OFF setting and adjustment of the voice correction process, the mobile phone terminal 1b provides the display as shown in FIG. 2 on the display screen in accordance with the received data. Thereby, the user B is enabled to learn or verify whether the “modification request” has been reflected into the mobile phone terminal 1a.

The case of transmission of the “modification request” is not limited to the case for adjusting the voice of the user A to be easily audible. The “modification request” can be transmitted as well in a case where, for example, the user B desires to hear ambient environmental sounds around the mobile phone terminal 1a when the ambient environmental sounds are substantially removed by execution of the voice correction process in the mobile phone terminal 1a. As such, in this case, the mobile phone terminal 1b transmits the “modification request” to the mobile phone terminal 1a to execute the operations, such as OFF setting of the voice correction process and adjustment for increasing of the correction amount of the voice correction process.

Further, according to the present embodiment, when having received the “modification request” from the mobile phone terminal 1b, the mobile phone terminal 1a is capable of setting for refusing to execute (own) operations, such as ON/OFF setting and adjustment of the voice correction process. More specifically, according to the present embodiment, by taking into account that, for example, a case can take place where it is inconvenient for the transmission-side user A to allow the user B on the transmitting side to hear ambient environmental sounds around the site of the user A, a setting for refusing the “modification request,” which requests for the operations, such as ON/OFF setting of the voice correction process and adjustment of the voice correction process, incoming from the far-end mobile phone terminal 1b is preliminarily registered or stored. Thereby, problems such as information leakage and privacy invasion can be prevented. Further, the mobile phone terminal 1a of the present embodiment enables the user to provide permission/refusal setting of whether the data regarding the type of voice correction function and the adjustment parameter of the voice correction process is transmitted to the far-end terminal.

As above, the present embodiment has been described with reference to the example case where the respective functions of the mobile phone terminals 1a and 1b are independent of one another. However, the mobile phone terminals 1a and 1b may both include the respective functions. In the case the mobile phone terminals 1a and 1b both include the same function, communication voice data or the like and, in addition, data regarding, for example, ON/OFF setting of the voice correction process and adjustment parameter of the voice correction process, are interactively transmitted or received between the mobile phone terminals 1a and 1b under voice communication. Further, data indicative of the state after operations, such as setting ON and adjustment of the voice correction process, are interactively transmitted or received between the mobile phone terminals 1a and 1b.

### (Interior Configuration (Schematically Viewed) of Mobile Phone Terminal)

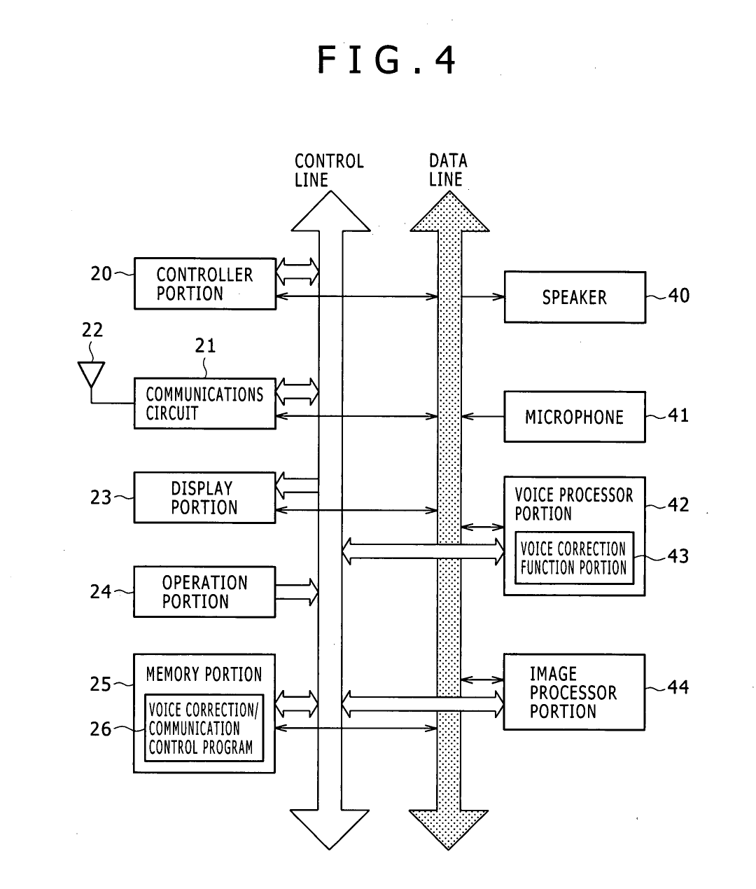

By way of example, FIG. 4 schematically shows an interior configuration of the respective mobile phone terminal 1a, 1b. Shown in FIG. 4 is an exemplary configuration in the case the respective mobile phone terminals 1a and 1b (of the users A and B) have the same function(s).

With reference to FIG. 4, a communication antenna 22 is, for example, a built-in antenna. The communication antenna 22 performs transmission and reception of radio signals for various types of communication, such as audio communication, packet communication, data communication using a call control server, and communication using channels other than a voice communication channel, such as currently unused channels and administration channels. A communication circuit 21 provides, for example, frequency conversion, modulation, and demodulation of a transmitted or received signal.

It is now contemplated that the received data received by the communication antenna 22 and the communication circuit 21 is receiving voice data. In this case, the receiving voice data is sent to a voice processor portion 42 through a data line. On the other hand, however, data such as those regarding the type of voice correction function and the adjustment parameter of the voice correction process of the function and various other received data, are once sent to a controller portion 20 and are processed therein. Then, the data are sent to respective portions from the controller portion 20. The data such as those regarding the type of voice correction function and the adjustment parameter of the voice correction process of the function are verified for the contents thereof in the controller portion 20, and then are used for control of a voice correction function portion 43 provided in the voice processor portion 42.

A speaker 40 is an audio outputting speaker provided to the mobile phone terminal (1a/1b) for outputting audio, such as receiving voice, “ringer” sounds (incoming sounds), replayed music audio, and alarm sounds. The speaker 40 includes a digital/analog converter and an amplifier, whereby, for example, communication voice, “ringer” sounds, and relayed music data are digital/analog converted, amplified, and then output.

A microphone 41 is an audio-transmission microphone including an analog/digital converter and an amplifier. A transmission voice signal input through the microphone 41 is amplified by the amplifier to a predetermined level and then is converted by the analog/digital converter to digital voice data, and then the data is transmitted to the voice processor portion 42 through the data line. In the case the mobile phone terminal of the present embodiment is of the type including the function of adjusting or shifting the microphone directivity for inhibiting input of ambient environmental noise, the microphone 41 capable of adjusting or shifting of the directivity is provided.

When supplied with receiving voice supplied from the communication antenna 22 and the communication circuit 21, the voice processor portion 42 decodes the receiving voice data and then sends the decoded receiving voice data to the speaker 40 through the data line. Alternately, when supplied with receiving voice input from the microphone 41, the voice processor portion 42 encodes the receiving voice data and then sends the encoded receiving voice data to the communication circuit 21 through the data line.

The voice correction function portion 43, which is provided in the voice processor portion 42, performs, by necessity, an voice correction process using, for example, the noise cancellation function (voice correction function), which removes ambient environmental noise component from voice data, on transmission voice data input from the microphone 41. The transmission voice data, which has been subjected to the voice correction process such as noise cancellation in the voice correction function portion 43, is encoded by the voice processor portion 42, and is then sent to the communication circuit 21 through the data line. Concurrently, data such as those regarding the type of voice correction function and the adjustment parameter of the voice correction process of the function in the voice correction function portion 43 are sent to the communication circuit 21 through the data line.

In the event of transmission from the mobile phone terminal, the transmission voice data or the transmission voice data subjected to the voice correction, and the data such as those regarding the type of voice correction function and the adjustment parameter of the voice correction process of the function are transmitted to the far-end mobile phone terminal through the data line.

The operation portion 24 includes a 12-key portion, arrow keys, on-hook key, clear key, off-hook/power on/off key, and other key operation devices provided on a housing of the mobile phone terminal of the present embodiment, and an operation signal generator that generates operation signals corresponding to operations of the respective operation devices. The user (A/B) operates the operation portion 24 to thereby carry out, for example, input specification of the “modification request” and specifying operations for specifying, for example, creation of an electronic mail (e-mail) text or massage,” transmission or reception of e-mail, linking to the Internet, and menu selection.

A display portion 23 includes a display (not shown), such as a liquid crystal display, provided on the housing of the mobile phone terminal, and a display driver circuit (not shown) for driving the display. More specifically, the display driver circuit drives the display in accordance with image signals supplied from an image processor portion 44. In response, the display displays on an image such as shown in FIG. 2 and various other images and characters, for example, on the screen.

The image processor portion 44 performs processes of images displayed on the display portion 23. The image processor portion 44 further performs display of, for example, various user interface screens and web pages under control of the controller portion 20.

A memory portion 25 includes a ROM (read only memory) (not shown) and a RAM (random access memory) (not shown). The ROM contains various data, information, programs, for example. They are, but not limited to, an OS (operating system); a control program for the controller portion 20 to control the respective portions, and various initial setup values; font data and respective dictionary data; a voice correction/communication control program 26 for control of the voice correction function and execution of various processes related to transmission/reception of data such as those regarding the voice correction function in accordance with the present embodiment; a telephone directory application program and various other application programs such as those contained in ordinary mobile phone terminals; and identification (ID) information of the mobile phone terminal. The ROM includes a rewritable ROM (not shown), such as a so-called NAND-type flash memory. The rewritable ROM may be used to additionally store, for example, specified or set data (“set data,” hereinbelow) for permission/refusal as a response to the “modification request,” set data for permission/refusal for the data regarding those such as the voice correction function, telephone directory data, e-mail data, schedule data, notepad data, image data, music data, downloaded application program codes, and various set values. The RAM provides work areas necessary for the controller portion 20 to execute various data processes, so that it stores data by necessity.

The controller portion 20 provides various types of control, such as control of communication in the communication circuit 21; control of execution of respective functions implemented by the voice correction/communication control program 26 of the present embodiment (control of the voice correction function, transmission or reception of data such as those regarding the voice correction function, and generation of the “modification request” data, for example). Further, the controller portion 20 further provides display control on the display, memory write/read control, control of the respective voice process and image process, control of the respective components of the mobile phone terminal, and performs various arithmetic operations.

Although not shown in FIG. 4, the mobile phone terminal of the present embodiment includes, for example, a camera portion for capturing images; an electronic wallet function portion for handling so-called “electronic money;” a GPS (global positioning system) for providing the current position fix; a near-field wireless communication portion for performing near-field wireless communication in accordance with a BlueTooth scheme (“BlueTooth”: registered trade mark), a UWB (ultra wide band) scheme, or the like; a time measuring portion for performing, for example, generation of date and time information and measuring the time; a memory interface portion for coupling to an external memory; cable connector portion for connecting an external cable; LEDs (light emitting diodes) for key illumination, incoming lighting, and the like purposes, and a driving portion therefor; a power management IC portion for controlling a battery, which supplies power to the respective portions; a power management IC portion for controlling supply of the battery power; and various other components such as those of an ordinary mobile phone terminal.

### Processing Related to Voice Correction Function of Receive-side Mobile Phone)

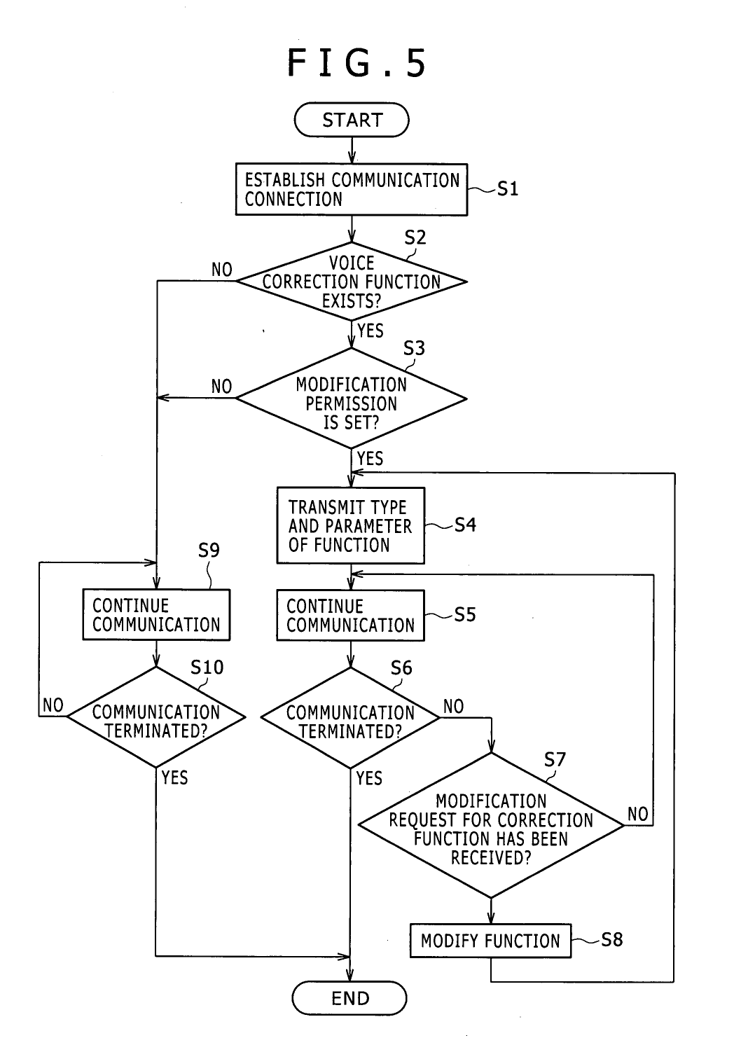

FIG. 5 is a flow diagram representing the flow of processing in the event that the respective portions of the receive-side mobile phone are controlled to operate in the manner that the voice correction/communication control program 26 stored in the memory portion 25 is executed by the controller portion 20 of the receive-side mobile phone of the present embodiment.

With reference to FIG. 5, when at step S1 communication connection through the communication circuit 21 and the communication antenna 22 is established, the processing proceeds to step S2. At step S2, by referencing set data for the voice processor portion 42 and the voice correction function portion 43, the controller portion 20 checks the type of the voice correction function mounted in the own (receive-side) mobile phone terminal and determines whether a voice correction function controllable by the controller portion 20 is present. If, at step S2, a controllable voice correction function is determined to be present, then the processing proceeds to step S3; and otherwise, if a controllable voice correction function in a controllable state is determined to be not present, then the processing proceeds to step S9.

At step S9, the communication process is continued in the current state until it is determined that the communication has been terminated either by communication discontinuation on the far-end terminal or by an off-hook operation performed on the own mobile phone. If, at step S10, it is determined that the communication has been terminated, the processing shown in the flow diagram of FIG. 5 terminates.

At step S3, the controller portion 20 determines whether the permission setting is specified for a “modification request” incoming from the far-end side (mobile terminal) regarding the controllable-state voice correction function. If the permission setting is not specified (that is, if the refusal setting is specified), then the processing proceeds to step S9. Otherwise, if the permission setting is specified, then the processing proceeds to step S4. At step S3, the controller portion 20 determines also whether a permission setting is specified for transmission of data such as those regarding the voice correction function to the far-end side. If the permission setting is specified (if the refusal setting for transmission of data such as those regarding the voice correction function), then the processing proceeds to step S9. Otherwise, if the permission setting is not specified, then the processing proceeds to step S4.

At step S4, the type of the controllable voice correction function and an adjustment parameter of the voice correction process are transmitted to the far-end terminal through the communication circuit 21 and the communication antenna 22.

Subsequently, at step S5, the communication process is continued. Then, at step S6, if it is determined that communication has been terminated either by communication discontinuation on the far-end terminal or by an off-hook operation performed on the own mobile phone, the processing shown in the flow diagram of FIG. 5 terminates. Otherwise, if the communication is not yet terminated, then the processing proceeds to step S7.

At step S7, the controller portion 20 determines whether a “modification request” has been transmitted from the far-end terminal. If a “modification request” has not been transmitted, then the processing returns to step S5. Otherwise, if a “modification request” has been transmitted, then the processing proceeds to step S8.

At step S8, the controller portion 20 controls the voice correction function portion 43 in accordance with the “modification request,” which has been transmitted from the far-end terminal. Thereby, a requested modification of the voice correction function is performed. After the process of step S8, the processing returns to step S4. Then, at step S4, the type of the voice correction function and the adjustment parameter of the voice correction process after the modification are transmitted to the far-end terminal.

### (Process Related to Voice Correction Function of Receive-side Mobile Phone Terminal)

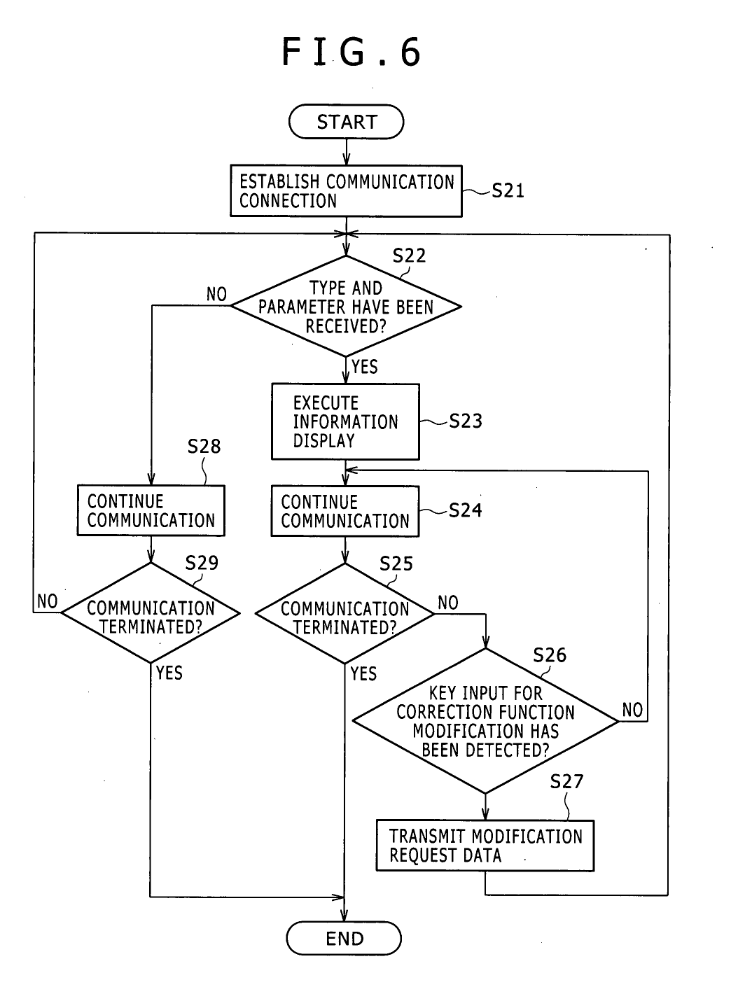

FIG. 6 is a flow diagram representing the flow of processing in the event that the respective portions of the receive-side mobile phone are controlled to operate in the manner that the voice correction/communication control program 26 stored in the memory portion 25 is executed by the controller portion 20 of the receive-side mobile phone of the present embodiment.

With reference to FIG. 6, when at step S21 communication connection through the communication circuit 21 and the communication antenna 22 is established, the processing proceeds to step S22. At step S22, the controller portion 20 monitors to determine whether data such as those regarding the type of the voice correction function and the adjustment parameter of the voice correction process of the function have been received. If the data such as those regarding the voice correction function have been received from the far-end terminal (i.e., the transmission-side terminal), at step S22, then the processing proceeds to step S23; and otherwise, if the data has not been received, then the processing proceeds to step S28.

At step S28, the communication process is continued in the current state until it is determined at subsequent step 29 that the communication has been terminated either by communication discontinuation on the far-end terminal or by an off-hook operation performed on the own mobile phone. Also, the communication process is continued at step S28 until it is determined at step S22 that the data such as those regarding the voice correction function have been received. If, at step S29, it is determined that the communication has been terminated, the processing shown in the flow diagram of FIG. 6 terminates.

At step S23, the controller portion 20 generates display data, which will be displayed in the form of an information display such as shown in FIG. 2, in accordance with the data such as those regarding the type of voice correction function and the adjustment parameter, which data have been received from the far-end terminal. Then, the generated display data is sent to the display portion 23. Upon receipt of the data, the display portion 23 presents on its display the information display such as shown in FIG. 2, thereby providing information presentation to the user.

Subsequently, at step S24, the communication process is continued. Then, at step S25, if it is determined that communication has been terminated either by communication discontinuation on the far-end terminal or by an off-hook operation performed on the own mobile phone, the processing shown in the flow diagram of FIG. 6 terminates. Otherwise, if the communication is not yet terminated, then the processing proceeds to step S26.

At step S27, the controller portion 20 determines whether a predetermined key-using input operation for transmitting a “modification request” to the far-end terminal has been carried out by the user on the operation portion 24. If the predetermined key-using input has not been carried out, then the processing returns to step S24. Otherwise, if the predetermined key-using input has been carried out, then the processing proceeds to step S27.

At step S27, the controller portion 20 generates data of a “modification request” corresponding to the contents of the predetermined key input, inclusive of data indicative of, for example, ON/OFF setting of any one of voice correction functions of the far-end terminal and how to set an adjustment parameter of the voice correction process. Then, the generated data of the “modification request” is transmitted to the far-end terminal through the communication circuit 21 and the communication antenna 22.

After the process of step S27, the processing returns to step S22. Then, at step S22, the controller portion 20 determines whether data such as those regarding the type of the voice correction function and the adjustment parameter of the voice correction process of the function after the modification has been received. If received, then, at step S23, information display is presented in accordance with the data such as those regarding the type of voice correction function and the adjustment parameter of the voice correction process of the function.

### (Conclusion)

As described above, according to the present embodiment, a transmission-side mobile phone terminal is capable of transmitting data such as those regarding the type of an own voice correction function and an adjustment parameter of a voice correction process of the function. A receive-side mobile phone terminal is capable of transmitting a “modification request” regarding the voice correction function of the transmission-side mobile phone. Thereby, the transmission-side mobile phone, which has received the “modification request,” is enabled to perform modification and adjustment of the own voice correction function. Further, the receive-side mobile phone terminal is able to verify the state of the voice correction process under way in the transmission-side mobile phone, and concurrently, is enabled to make the request for the modification and adjustment of the voice correction process to the transmission-side mobile phone. The embodiment thus arranged makes it possible to prevent occurrence of a state where inherently necessary data is lost by the voice correction function of the transmission-side mobile terminal from transmission voice. Further, the embodiment makes it possible to obtain easy-to-hear receiving voice through the receive-side mobile terminal. Further, the embodiment makes it possible to address even a case where the user of the receive-side communication apparatus desires to hear transmission voice together with ambient environmental sounds, thereby to effectively use, by necessity, the voice correction function of the transmission-side mobile terminal.

The present embodiment is just one example, so that the present invention is not limited in any way to the embodiment. The present invention can of course be modified in various ways corresponding to design and the like without departing from the spirit and scope of the invention.

While the embodiment has been described focusing on the voice correction function, the present invention can be adapted to, for example, a TV phone system where an image correction process is performed for images that are transmitted or received together with voice. Even in this case, similarly as in the above-described case, data regarding an image correction function in a transmission-side terminal is transmitted to a receive-side terminal, whereby the image correction function is controlled in the transmission-side terminal in accordance with a “modification request” received from the receive-side terminal.

Further, many other variations and modifications and other uses will become apparent to those skilled in the art. Accordingly, the present invention is not to be limited by the specific description herein, but only by the appended claims.

What is claimed is:

1. An audio communication apparatus for performing communication for at least voice communication, the apparatus comprising:
a voice input portion for inputting voice;
a voice correction processor portion for performing, by necessity, a voice correction process of the voice input from the voice input portion;
a communication portion for performing communication with a far-end communication apparatus; and
a controller portion for executing control during voice communication being performed with the far-end communication apparatus through the communication portion so that
data regarding a voice correction function of the voice correction processor portion are transmitted, by necessity, from the communication portion to the far-end communication apparatus, and
when a modification request for the voice correction function of the voice correction processor portion of the audio communication apparatus is received from the far-end communication apparatus through the communication portion, the voice correction process of the voice correction processor portion is controlled in accordance with the modification request.

2. An audio communication apparatus according to claim 1, wherein the controller portion performs control operation so that
as the data regarding the voice correction function, at least data regarding a type of the voice correction function of the voice correction processor portion and an adjustment parameter of the voice correction function are transmitted to the far-end communication apparatus from the communication portion, and
when a modification request for either the type of the voice correction function of the voice correction processor portion of the audio communication apparatus or the adjustment parameter of the voice correction function has been received from the far-end communication apparatus through the communication portion, the voice correction process of the voice correction processor portion is controlled in accordance with the modification request.

3. An audio communication apparatus according to claim 1, further comprising a data preserving portion for preserving set data regarding permission/refusal for control of the voice correction process, wherein
the controller portion determines whether to execute control of the voice correction process of the voice correction processor portion in accordance with the set data preserved in the data preserving portion.

4. An audio communication apparatus according to claim 1, further comprising a data preserving portion for preserving set data regarding permission/refusal for transmission of the data regarding the voice correction function of the voice correction processor portion, wherein
the controller portion determines whether to execute transmission of the data regarding the voice correction function in accordance with the set data preserved in the data preserving portion.

5. An audio communication apparatus for performing at least voice communication, the apparatus comprising:
a communication portion for performing communication with a far-end communication apparatus;
a presentation portion for performing information presentation to a user;
an operation input portion for inputting contents of an input operation of the user; and
a controller portion for executing control during voice communication being performed with the far-end communication apparatus through the communication portion so that
when data regarding a voice correction function of the far-end communication apparatus is received through the communication portion, information in accordance with the data regarding a voice correction function is presented to the user through the communication portion, and
when contents of a predetermined operation regarding modification of the voice correction function of the far-end communication apparatus has been input from the user through the operation input portion, data of a modification request regarding the voice correction function corresponding to the predetermined operation are generated and transmitted from the communication portion to the far-end communication apparatus.

6. An audio communication apparatus according to claim 5, wherein the controller portion performs control operation so that
when, the data regarding the voice correction function, data regarding a type of the voice correction function of the far-end communication apparatus and an adjustment parameter of the voice correction function have been received through the communication portion, information in accordance with the data regarding the type of the voice correction function of the far-end communication apparatus and the adjustment parameter are presented to the user, and
when contents of a predetermined operation regarding modification of either the type or the adjustment parameter of the voice correction function of the far-end communication apparatus has been input from the user, data of a modification request regarding either the type or the adjustment parameter of the voice correction function corresponding to the predetermined operation are generated and transmitted from the communication portion to the far-end communication apparatus.

7. An audio communications system including audio communication apparatuses for performing communication for at least voice communication, wherein
a transmission-side audio communication apparatus comprises at least:
a voice input portion for inputting voice;
a voice correction processor portion for performing, by necessity, a voice correction process of voice input from the voice input portion;
a communication portion for performing communication with a far-end communication apparatus; and
a controller portion for executing control during voice communication being performed with the far-end communication apparatus through the communication portion so that
data regarding a voice correction function of the voice correction processor portion are transmitted, by necessity, from the communication portion to the far-end communication apparatus, and
when a modification request for the voice correction function of the voice correction processor portion of the audio communication apparatus is received from the far-end communication apparatus through the communication portion, the voice correction process of the voice correction processor portion is controlled in accordance with the modification request, and
a receive-side audio communication apparatus comprising at least:
a communication portion for performing communication with a far-end communication apparatus;
a presentation portion for performing information presentation to a user;
an operation input portion for inputting contents of an input operation of the user; and
a controller portion for executing control during voice communication being performed with the far-end communication apparatus through the communication portion so that
when data regarding a voice correction function of the far-end communication apparatus is received through the communication portion, information in accordance with the data regarding a voice correction function is presented to the user through the communication portion, and
when contents of a predetermined operation regarding modification of the voice correction function of the far-end communication apparatus has been input from the user through the operation input portion, data of a modification request regarding the voice correction function corresponding to the predetermined operation are generated and transmitted from the communication portion to the far-end communication apparatus.

8. An audio communication control method for performing communication for at least voice communication, the method comprising the steps of:
inputting voice through a voice input portion;
performing, by necessity, a voice correction process of the voice input from the voice input portion, the voice correction process being performed by a voice correction processor portion;
during voice communication being performed with a far-end communication apparatus through a communication portion, transmitting data regarding a voice correction function of the voice correction processor portion, by necessity, from the communication portion to the far-end communication apparatus under control of a controller portion; and
during voice communication being performed with the far-end communication apparatus through the communication portion, when a modification request for the voice correction function of the voice correction processor portion of the audio communication apparatus is received from the far-end communication apparatus through the communication portion, executing control of the voice correction process of the voice correction processor portion in accordance with the modification request, the control being executed by the controller portion.

9. An audio communication method for performing at least voice communication, the method comprising the steps of:
during voice communication being performed with a far-end communication apparatus, when data regarding a voice correction function of the far-end communication apparatus is received through the communication portion, performing presentation of information in accordance with the data regarding a voice correction function to a user through the communication portion, the presentation being performed under control of a controller portion; and
during voice communication being performed with the far-end communication apparatus, when contents of a predetermined operation regarding modification of the voice correction function of the far-end communication apparatus has been input from the user through an operation input portion, performing generation and transmission of data of a modification request regarding the voice correction function corresponding to the predetermined operation are generated and transmitted from the communication portion to the far-end communication apparatus, the generation being performed by the controller portion, and the transmission being performed under control of the controller portion.

10. An audio communication control program for an audio communication apparatus that performs communication for at least voice communication, the apparatus including a voice input portion for inputting voice and a communication portion for performing communication with a far-end communication apparatus, wherein the program comprises:
causing a computer to function as a voice correction processor portion that performs, by necessity, a voice correction process of the voice input from the voice input portion; and
causing the computer to function as a controller portion that executes control during voice communication being performed with the far-end communication apparatus through the communication portion so that
data regarding a voice correction function of the voice correction processor portion are transmitted, by necessity, from the communication portion to the far-end communication apparatus, and
when a modification request for the voice correction function of the voice correction processor portion of the audio communication apparatus is received from the far-end communication apparatus through the communication portion, the voice correction process of the voice correction processor portion is controlled in accordance with the modification request.

11. An audio communication control program for an audio communication apparatus that performs communication for at least voice communication, the apparatus including a communication portion for performing communication with a far-end communication apparatus, a presentation portion for performing information presentation to a user of the audio communication apparatus, and an operation input portion for inputting contents of an input operation of the user, wherein the program comprising:
causing a computer to function as a controller portion for executing control during voice communication being performed with the far-end communication apparatus through the communication portion so that
when data regarding a voice correction function of the far-end communication apparatus is received through the communication portion, information in accordance with the data regarding a voice correction function is presented to the user through the communication portion, and
when contents of a predetermined operation regarding modification of the voice correction function of the far-end communication apparatus has been input from the user through the operation input portion, data of a modification request regarding the voice correction function corresponding to the predetermined operation are generated and transmitted from the communication portion to the far-end communication apparatus.
